(19) United States
(12) Patent Application Publication
(10) Pub. No.: US 2003/0004792 A1
(43) Pub. Date: Jan. 2, 2003

(54) System and method to remotely control and monitor a parking garage revenue system and gate via an open network connection

(76) Inventors: Conn L. Townzen, Houston, TX (US); G. Neal Horner, Houston, TX (US); Joe Mitchell, Magnolia, TX (US)

Correspondence Address: THOMPSON & KNIGHT, L.L.P., PATENT PROSECUTION GROUP, 1700 PACIFIC AVENUE, SUITE 3300, DALLAS, TX, 75201, US

(21) Appl. No.: 09/897,774

(22) Filed: Jun. 29, 2001

(51) Int. Cl. G06F 17/60

(52) U.S. Cl. 705/13

(57) ABSTRACT

A system and method to remotely control and monitor a parking garage gate or parking lot access gate via an open network, such as the Internet. The system comprises a gate controller system and a remote terminal. The gate controller system is located at a parking garage. The gate controller system is adapted to control the movement of the gate. The remote terminal is located at a remote location, and is communicably coupled to the gate controller via an open network. The method comprises the following steps, the order of which may vary: (i) providing a gate controller system located at a parking garage and being adapted to control the movement of the gate; (ii) providing a remote terminal at a remote location apart from the parking garage, the remote terminal being communicably coupled to the gate controller system via an open network; (iii) sending a command from the remote terminal to the gate controller system via the open network; and (iv) moving the gate with the gate controller system in response to the command from the remote terminal.

### FIELD OF THE INVENTION

The present invention relates to a system and method to remotely control and monitor a parking facility revenue system and/or a gate via an open network connection, such as an Internet connection.

### DESCRIPTION OF RELATED ART

There have been and there are currently numerous ways to control and monitor parking garage access gates. For example, some parking garage gates have a guard/teller booth at the gate attended by a person. The person in the guard/teller booth typically can communicate with parking garage patrons, receive money from patrons and make change for cash transactions, receive validated parking coupons, receive credit card payment, monitor patrons leaving the parking garage, watch for theft, monitor images from video cameras in or around the parking garage, notify emergency services (e.g., fire, ambulance, police) in the invent of an emergency or crime, control the gate operation, and/or assist monthly contract patrons if their access card malfunctions. However, it is sometimes impractical and/or too expensive to keep such a guard/teller booth manned all the time (24 hours a day, 7 days a week). This often presents problems for patrons attempting to exit a parking garage after the parking garage attendant has left (i.e., when the guard/teller booth is unmanned). Hence, there is a need for a way to control and/or monitor a parking garage gate when it is impractical and/or too expensive to have a person working at a guard/teller booth.

A downside to having an on-site parking attendant is that it is difficult to monitor or prevent such attendants from skimming money for themselves. If the attendant were somehow removed from the handling the money directly, it could possibly eliminate the opportunities for such theft. Hence, there is a need for a way to prevent or eliminate the problem of theft by on-site attendants.

Although, some of the more recent gate control systems are essentially personal computers at the parking garage facility having software loaded therein and/or controller interface cards therein for actuating electric motors. However, if the software provider comes out with a new and improved version of the software (e.g., to repair prior bugs or to add enhanced functionality and feature), the software must be loaded, and perhaps configured, at each site. This makes it somewhat undesirable for a user to purchase an upgrade and it can decrease the frequency of such updates. Hence, there is a need for a way to more conveniently provide and upgrade the software on the system.

There are currently systems where numerous gates and numerous video cameras are monitored from a guard station at or near the parking garage facility. Such configurations often use a call box at the gate to communicate with parking garage patrons from the guard station, and video cameras can be used to obtain images of the gate scene. This type of configuration allows for one person to monitor multiple gates at a facility, but it still requires a person to be on site to work at the guard station.

Some companies offer contract services to remotely monitor the security of a location. In such arrangements, there is a direct connection between the monitoring agency and the parking garage site. Often video cameras, door alarms, and fire detectors are monitored from the remote site. Such arrangements require dedicated lines for each site and are often limited to a single location for the remote monitoring station.

Some systems record or log data relating to activities at the parking garage, such as time and access card number for the entrance/exit of a monthly contract patron. Such data is typically stored on a computer at the parking garage facility or at a remote monitoring station. But such information is often not readily available and accessible from other locations.

Some systems offer automated payment devices. In such arrangements, devises are provided to directly communicate with the parking equipment system to calculate fees based on time, rate, and appropriate discount validations. But due to real or perceived difficulty of use, consumers do not readily accept such devices. This results in on-site assistance being necessary. A device to reduce this assistance requirement would likely increase the acceptance of these devices, and their greater acceptance would reduce the requirement for on-site personnel and cashiers.

With the aforementioned arrangements and configurations, the only way that an owner or manager of a parking garage facility can interface with the gate controller system or easily obtain recorded data regarding the parking garage facility is by making a trip to the parking garage site or to the remote monitoring location of the contractor, or by contacting (e.g., via phone, email message, or fax) a person that is monitoring and controlling the gate. Hence, there is a need for a way for a user to monitor and/or control the activity of a parking garage gate from any location where the user may be.

### BRIEF SUMMARY OF THE INVENTION

The problems and needs outlined above are largely solved and met by the present invention. In accordance with one aspect of the present invention, a system for remotely controlling passage through a gate at a parking garage is provided. The system comprises a gate controller system and a remote terminal. The gate controller system is located at a parking garage. The gate controller system is adapted to control the movement of the gate. The remote terminal is located at a remote location, and is communicably coupled to the gate controller via an open network connection.

In accordance with another aspect of the present invention, a web based parking garage gate system is provided. The system comprises a gate controller system and an application service provider computer system. The gate controller system is located at a parking garage and is adapted to control the movement of a parking garage gate at the parking garage. The application service provider computer system is located remotely from the gate controller system. The gate controller system is communicably coupled to the application service provider computer system. The application service provider computer system comprises code and data adapted to generate a web site that allows users at a remote location to interact with the gate controller system via the Internet.

In accordance with yet another aspect of the present invention, a system for controlling passage through a gate for a parking garage is provided. The system comprises a first computer system, a second computer system, and a server computer system. The first computer system is located at the parking garage, and is adapted to control the movement of the parking garage gate. The first computer system is communicably coupled to the Internet. The second computer system is located remotely from the first computer system. The second computer system is capable of communicably coupling to the Internet as needed. The server computer system comprises a software program adapted to provide code and data to the second computer system via the Internet. The code and data is adapted to output a graphical user interface with text on the second computer system. The graphical user interface with text comprises an interface to allow a user at the second computer system to control the parking garage gate remotely via the Internet.

In accordance with still another aspect of the present invention, a parking garage gate system is provided. The system comprises a gate controller system and an application service provider computer system. The gate controller system is located at a parking garage and is adapted to control the movement of the parking garage gate. The application service provider computer system is located remotely from the gate controller system and the gate. The gate controller system is communicably coupled to the application service provider computer system via the Internet. The application service provider computer system comprises a software program adapted to interact with and control the gate controller system from the remote location.

In accordance with a further aspect of the present invention, a system for controlling the usage of a parking garage is provided. The system comprises a gate, a gate controller system, a remote terminal, and a software program. The gate at least partially blocks an automobile passageway for the parking garage. The gate controller system is located at the parking garage, and is adapted to control the movement of the gate. The remote terminal is located at a remote location apart from the parking garage. The remote terminal is communicably coupled to the gate controller via the Internet. The software program is adapted to run on the remote terminal and is adapted to allow a user at the remote location to be in command of the gate controller system.

In accordance with another aspect of the present invention, a method of controlling passage through a parking garage gate is provided. The method comprises the following steps, the order of which may vary: (i) providing a gate controller system located at a parking garage and being adapted to control the movement of the gate; (ii) providing a remote terminal at a remote location apart from the parking garage, the remote terminal being communicably coupled to the gate controller system via an open network connection; (iii) sending a command from the remote terminal to the gate controller system via the open network connection; and (iv) moving the gate with the gate controller system in response to the command from the remote terminal.

In accordance with yet another aspect of the present invention, a method of controlling passage of a vehicle of a parking garage patron through an unmanned gate at a parking garage is provided. The method comprises the following steps, the order of which may vary: (i) providing a first computer system at the parking garage, the first computer system being communicably coupled to the Internet via a secure connection; (ii) providing a mechanism at the gate, the mechanism being adapted to move the gate in response to control signals from the first computer system; (iii) providing a second computer system located at a remote location relative to the first computer system and the parking garage, wherein the second computer system is adapted to be communicably coupled to the Internet as needed; (iv) communicating with the patron at the gate from the remote location using the computer systems and via the Internet; (v) authorizing passage of the patron through the gate from the remote location; (vi) sending a gate movement command from the second computer system to the first computer system via the Internet; and (vii) moving the gate to allow the patron to pass through the gate based on the gate movement command.

In accordance with still another aspect of the present invention, a method of providing remote assistance at a parking gate is provided. The method comprises the following steps, the order of which may vary: (i) providing a first computer system at the parking facility, the first computer system being communicably coupled to the Internet via a secure connection; (ii) providing a mechanism at the gate, the mechanism being adapted to move the gate in response to control signals from the first computer system; (iii) providing an interface system at a payment transaction device being adapted to transmit and receive audio and video information for communicating with a parking patron; (iv) providing a presence detection device to sense the presence of said patron at said payment transaction device; (v) providing a second computer system located at a remote location relative to the first computer system and the parking facility, wherein the second computer system is adapted to be communicably coupled to the Internet as needed; (vi) communicating with the patron at the gate from the remote location using the computer systems and via the Internet; (v) providing assistance in processing payments via an onsite cash accepter or an onsite credit card processor or an offsite credit card processor; (vi) authorizing passage of the patron through the gate from the remote location; (vi) sending a gate movement command from the second computer system to the first computer system via the Internet; and (vii) moving the gate to allow the patron to pass through the gate based on the gate movement command.

### BRIEF DESCRIPTION OF THE DRAWINGS

Other objects and advantages of the invention will become apparent upon reading the following detailed description and upon referencing the accompanying drawings, in which:

FIG. 1 is a simplified schematic showing a system in accordance with a first embodiment of the present invention;

FIG. 2 is a simplified schematic showing a system in accordance with a second embodiment of the present invention;

FIG. 3 is a simplified schematic showing a system in accordance with a third embodiment of the present invention;

FIG. 4 is a simplified schematic showing a system in accordance with a fourth embodiment of the present invention;

FIG. 5 is a simplified schematic showing a system in accordance with a fifth embodiment of the present invention; and

FIG. 6 is a simplified schematic showing a system in accordance with a sixth embodiment of the present invention.

### DETAILED DESCRIPTION OF THE INVENTION

Referring now to the drawings, wherein like reference numbers are used herein to designate like elements throughout the various views, embodiments of the present invention are illustrated and described, and other possible embodiments of the present invention are described. The figures are not necessarily drawn to scale, and in some instances the drawings have been exaggerated and/or simplified in places for illustrative purposes only. One of ordinary skill in the art will appreciate the many possible applications and variations of the present invention based on the following examples of possible embodiments of the present invention.

The term “mechanically coupled” as used herein means that the two components may be directly or indirectly mechanically coupled in a variety of ways. Hence, there can be things or mechanisms in-between acting as couplers. For example, an electric motor that drives the motion of a gate can be “mechanically coupled” to the gate in numerous ways, including but not limited to: by being directly coupled; by having a shaft extending between the electric motor and the gate; by a universal joint; by a transmission; by a linkage; by a sprocket and chain; by a gear head on the electric motor; by a gear box; by a belt with pulleys; by a clutch mechanism; by a spring member; by a slider; by a pivot; or by any combination thereof. Among these examples of “mechanically coupling” an electric motor to a gate, the thing that remains constant is that the electric motor is driving the motion of the gate via the “mechanical coupling,” whatever it may be.

The term “communicably coupled” is used herein to generically refer to any type of communication connection between one devices and/or computer system and another device and/or computer system. When one device and/or computer system is “communicably coupled” to another device and/or computer system, it can be either direct or indirect. For example, two devices are “communicably coupled” indirectly when routers, switches, other devices, and/or other computer systems are used, encountered, or passed through along the path for the purpose of compressing, decompressing, modulating, buffering, and/or transmitting the communication. The communication path or medium for communicating analog signals and/or digital data between one device and/or computer system “communicably coupled” to another device and/or computer system may include, but without limitation to: a wire, a fiber-optic cable, a coaxial cable, a pair of twisted wires, a local area network, an intranet, a wide area network, an ethernet line, a plain old telephone system, a T1 trunk, a T3 trunk, an E1 trunk, an ISDN line, a private wide area network, a public wide area network, a token ring, a cellular communications service, a direct dial-up ftp line, a cable television cable network system, a public telephone network, an Internet Protocol (IP) line or network, a dedicated communication line, a satellite communication system, a microwave communication system, a laser communication system, a photonic communication system, an infrared light communication system, a digital switch network, a PBX, a public communications system, the world wide web, the Internet, or any combination thereof. For example, two devices may be “communicably coupled” using hard-wire-type connections, such as phone lines, POTS, T1 lines, DSL, cable television network, modem, SCSI connection, fiber optic, Ethernet, twisted pair, switches, token rings, local area network, PBX, wide area network, Internet connections, etc. Also, two devices may be “communicably coupled” using wireless connections adapted to carry communication such as via electromagnetic waves, satellite transmission, microwaves, laser light, wireless optics (e.g., infrared), etc. Further, the term includes logical connections between two processes on the same system and processes connected by a common computing device's memory space. Thus, the technology by which the communication is transmitted is not material to the meaning of “communicably coupled.”

The term “application service provider” or “ASP” is used herein to generically refer to any person, entity, corporation, or organization that provides one or more software applications to at least one user, that develops at least one software application for at least one user, that maintains and updates at least one software application for at least one user, and/or that provides services related to at least one software application (e.g., customer service, data storage, data retrieval, data processing, technical support, providing and maintaining server space, providing communication connections, improving a software application, monitoring the functionality of a computer system, creating an audit trail for data received, preparing reports for at least one user, customizing a software application for a user's needs or desires, etc.).

The term “application service provider computer system” or “ASP computer system” is used herein to generically refer to a computer system of an application service provider, which is typically used by the application service provider, at least in part, to provide products and services. An application service provider computer system may be in a single location or it may distributed in pieces (e.g., scalable pieces or modules) in many locations that are interconnected with each other by a communications network or any other way of communicating among computer system components. Typically an “application service provider computer system” will comprise at least one server computer. An “application service provider computer system” may also comprise at least one database and/or communication ports adapted to send and/or receive analog and/or digital data to and/or from at least one other computer system (e.g., a user computer system).

The term “program” as used herein refers to code in the form of software adapted to run on a computer machine; logic and algorithms permanently formed with hardware, permanently burned into an E-PROM, or temporarily stored in a memory device; or any combination thereof.

An “open network” is a communication network that anyone can connect to. In other words, access to an “open network” is not restricted and is available to the general public. The most prevalent and largest open network is the Internet and the world wide web. In contrast, a closed network is an intranet or a local area network (LAN) that requires permission to connect to or that requires a dedicated connection point. An “open network connection” is formed when a device or computer system is communicably coupled to an open network such that it can access other computer systems or networks communicably coupled to the open network, transmit data to and/or from another computer system or network communicably coupled to the open network, and/or communicate with another computer system or network communicably coupled to the open network. Thus for example, a connection to the Internet (e.g., via an Internet service provider), by whatever route or means, is an open network connection. Typically publicly accessible web sites or web pages are posted on an open network. There may be restricted areas of an open network that require a password to log in, but as long as such restricted areas are accessed via the publicly accessible open network, i.e., via an open network connection, it is still a sub-part of the open network.

The terms “parking garage,” “parking lot,” and “parking facility” are used interchangeably herein, and each can refer to any type of facility or lot for parking vehicles, which may be completely enclosed, partially enclosed, completely outdoor or open, fenced, or any combination thereof. As use herein, the terms “parking garage,” “parking lot,” and “parking facility” include outdoor or indoor public parking lots where patrons pay to park, or where the parking is free upon presentation of a parking validation (e.g., a parking lot or garage for a store). Such public parking lots typically have some form of barrier to inhibit vehicles from exiting the lot from anywhere other than a designated exit passageway or a designated gate. The terms “parking garage,” “parking lot,” and “parking facility” also include multi-floor structures, as commonly located in downtown areas or where footprint space is limited. Furthermore, the terms “parking garage,” “parking lot,” and “parking facility” include underground parking facilities, which are often located beneath a building. Some parking facilities are private (e.g., residential parking garage), some are public (e.g., anyone can pay to park there by the hour or day), some are contract parking (e.g., a company, firm, or person pays a monthly fee to park there), and some are combinations thereof (e.g., private lot with visitor parking, residential garage with visitor parking, contract parking garage that also provides paid parking). Typically a parking garage has some type of access gate, door, or barrier to limit or regulate entrance and/or exiting from the parking garage.

Other technical terms used herein will typically have the ordinary meaning as known to one having ordinary skill in the art, and/or may be defined by reference to the latest edition of Newton's Telecom Dictionary, which tends to evolve as the technology terminology evolves and which is incorporated by reference herein.

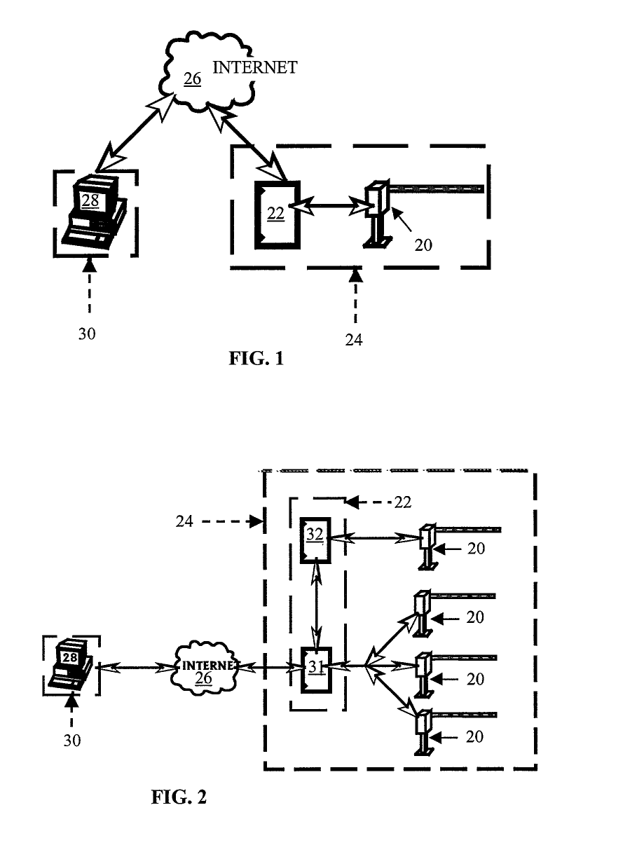

The present invention relates to a system and method to remotely control and/or monitor a parking garage gate or parking lot access gate via an open network connection, such as a secure Internet connection. FIG. 1 is a simplified schematic of a first embodiment of the present invention. In the first embodiment of FIG. 1, a parking garage gate 20 is communicably coupled to a gate controller system 22 at the parking garage location 24. Each gate 20 has a mechanism for moving the gate in response to a signal or signals from the gate controller system 22. Such a mechanism can vary and there are many commonly known mechanisms that can move a gate 20 in response to a signal from a gate controller system 22, which should be known to one of ordinary skill in the art. Hence, the details of the mechanism are not discussed herein.

As used herein, a gate controller system 22 can be: a computer system, a single personal computer, a server, a rack of computers, a specialized piece or group of hardware with limited functions compared to a general use personal computer, an application service provider computer system, or any combination thereof.

The gate controller system 22 in the first embodiment is a combination of hardware components specifically designed to perform the functions needed to control the movement of the gate 20, to link the gate controller system 22 to the Internet 26 (e.g., using a modem), and to establish a secure connection or session with another computer system linked to the Internet. Hence, the gate controller system 22 of the first embodiment has limited functionality and capabilities, as opposed to a general purpose personal computer. However, a general purpose personal computer with the appropriate software and interface cards may also be used in providing the gate controller system 22. Also, the gate controller system 22 in FIG. 1 is shown as a separate component for illustrative purposes. The gate controller system 22 may be located anywhere at the parking garage facility 24, such as a climate controlled area, near elevator electronic equipment, or a locked closet. But in alternative, the gate controller system 22 may be located inside of or attached to the gate housing as part of the gate assembly 20.

A remote terminal 28 is shown in FIG. 1 linked to the Internet 26. As used herein, a remote terminal 28 can be: a computer system, a single personal computer, a server, a rack of computers, a specialized piece or group of hardware with limited functions compared to a general use personal computer, an application service provider computer system, or any combination thereof. The remote terminal 28 of the first embodiment is a computer system at a remote location 30 apart from and away from the parking garage location 24. The remote terminal 28 is communicably coupled to the gate controller system 22 via the Internet 26 using a secure connection (e.g., SSL connection using cryptography). Because the remote terminal 28 is communicably coupled to the gate controller system 22 via the Internet 26, the remote terminal 28 may be located anywhere in the world where some type of communication connection to the Internet 26 is available.

There are several advantages to having the remote terminal 28 communicably coupled to the gate controller system 22 via the Internet 26. First, it allows someone to monitor the activity at the gate 20, provide assistance to parking garage patrons, control the gate 20, and provide most any other needs that an on-site parking attendant can provide, but the person monitoring and controlling the gate 20 can be anywhere in the world. So, for example, a parking garage gate in Dallas, Tex. can be monitored and controlled by a person working out of his/her house in Chicago. Depending on the devices located at the gate 20, the “virtual” parking lot attendant in Chicago could: speak with parking garage patrons via a communications system (e.g., microphone and speakers); look at the patron via images from a digital video camera located within viewing proximity to the gate 20, where the digital images are sent to his/her remote terminal 28 from the gate controller system 22 via the Internet 26; view a parking ticket with a time stamp and validation stamp scanned into the gate controller system 22 at the gate 20 by the patron and transmitted to the remote terminal 28 via the Internet 26; and/or visually authenticate the identity of a patron using a still camera image transmitted from the gate 20 by the gate controller system 22 via the Internet 26.

As long as the person monitoring and controlling the gate 20 at the remote location 30 has a sufficiently-sized computer system and an Internet connection with sufficient bandwidth or speed, it doesn't matter where that person is located. This can save on overhead expenses of providing a dedicated office or station for providing a parking garage attendant.

Second, because the communication connection between the gate controller system 22 and the remote terminal 28 is not limited to a dedicated line going to a monitoring station, as the parking garage attendants change shifts, the location 30 of the remote terminal 28 can likewise change. For example, one person may monitor and control the gate 20 for a certain shift or for certain days who works for a service company in California. Then, another person may monitor and control the same gate 20 for another shift or on other days who works for the same service company at a New York location. And yet another person may monitor and control the same gate 20 for yet another shift or on other days who is an independent contractor working out of his beach house in Florida. Thus, the locations of the persons monitoring and controlling the gate 20 can vary. The present invention allows a parking garage owner to shop around the country or around the world for the best priced “virtual” parking attendants. Also, the present invention provides employment opportunities for persons that cannot leave their home for health reasons, as well as for persons living in rural areas where jobs may be scarce.

A third advantage of the present invention is that an owner and/or manager of a parking garage 24 can monitor the activity at the parking garage or download prior data stored by the gate controller system 22 for prior activities from anywhere via the Internet 26. So, for example, if the owner of a Las Vegas parking garage lives in Michigan, he/she can check up on the activity of the parking garage from his/her computer in his/her office in Michigan. This may be a very desirable feature for a parking garage owner.

A fourth advantage of the present invention is that a single “virtual” parking attendant may monitor numerous parking garage gates 20 at numerous locations from the same remote terminal 28. For example, a person at a remote terminal located in Alaska could monitor and control a gate in Montana parking garage, two gates at a Colorado parking garage, and four gates at a Utah parking garage at the same time.

A fifth advantage of the present invention is that a “virtual” parking attendant located remotely (i.e., off-site) from the parking facility eliminates the opportunities for the attendant to steal money being handled. All of the money interchange occurs on-site using a money machine. Thus, all of the actions and transactions by the money machine can be tracked and/or recorded. Also, the attendant does not get an opportunity to physically handled the money.

A sixth advantage of the present invention is that having a person available to assist patrons at the gate, even though being remotely located, provides a level of comfort for patrons that are not familiar with, not accustomed to, and/or not comfortable with interfacing a computer and/or machine only. A system in accordance with the present invention may provide audio and video communication between a patron and the “virtual” attendant (i.e., “face-to-face” type interaction via cameras, microphones, and video monitors). As people in a given region or at a given site become more comfortable with the computer and/or machine interfaces, the attendants will likely become less needed or not needed at all. Thus, the present invention provides a good transition from gates with on-site attendants toward gates having only machine and/or computer automated interactions for transactions.

FIG. 2 is a simplified schematic of a second embodiment of the present invention. In the second embodiment, there are four gates 20 connected to the gate controller system 22. The gate controller system 22 has two components 31, 32. A first component 31 of the gate controller system 22 is a general purpose computer system (personal computer) having software and hardware for controlling the gates 20, for interfacing with and communicating with a second component 32 of the gate controller system 22, and for forming a secure open network connection. The second component 32 of the gate controller system 22 is a piece of dedicated hardware similar to the gate controller system of the first embodiment. The second component 32 controls the movement of a single gate 20 and has hardware allowing it to interface with the first component 31 of the gate controller system 22. Thus, the gate controller system 22 is scaleable and can comprise multiple similar or different components for controlling the motion of one or more gates 20, as well as any other devices that need to interact with the gate controller system 22.

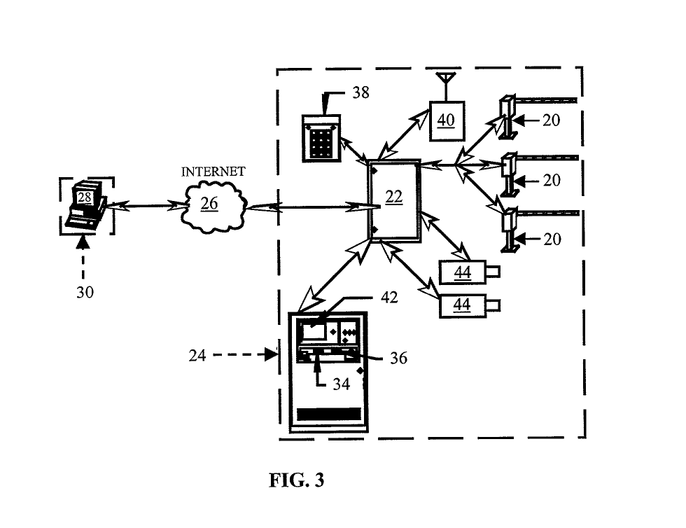

FIG. 3 is a simplified schematic of a third embodiment of the present invention. In the third embodiment of FIG. 3, the gate controller system 22 is a rack of computer components and a server. As in the first embodiment, the gate controller system 22 is communicably coupled to a remote terminal 28 via the Internet 26. The gate controller system 22 of the third embodiment is communicably coupled to a number of components for interacting with a parking garage patron at a gate 20 of a parking garage, for controlling access into or out of the parking garage, and for monitoring activities at the gates or in and around the parking garage. The components communicable coupled to the gate controller system 22 include: three gates 20; a magnetic strip scanner 34 for cards (e.g., for scanning credit cards, ATM (automated teller machine) debit cards, prepaid cards, access cards, validated tickets, and/or time stamp cards); a cash machine 36; a numeric keypad 38; a toll tag scanner 40; a touch screen monitor 42; and two video cameras 44. These components shown in the third embodiment are just some of the possible components that may be communicably coupled to the gate controller system 22. There are other components (not shown) that also may be communicably coupled to the gate controller system 22 for an embodiment of the present invention, including but not limited to: a presence detector for detecting when a person or vehicle at a gate, a fingerprint scanner, an eye scanner, a license plate recognition system, a radio receiver, a microphone, a speaker, a voice recognition system, a bar code scanner, a face recognition scanner, a chip reader, a keyboard, a monitor, a television, a call button, a vehicle sensor embedded in the pavement at the gate, an infrared camera, a thermal heat sensor, a motion detector, another computer system, a database, a printer, a document scanner, a telephone, a pay phone, a fuel pump, a fuel meter, a parking meter, a scent detection device, a transmitter, or any combination thereof. Because the gate controller system 22 of the third embodiment is a multipurpose computer system, it comprises software and hardware for interfacing with and communicating with the components communicably coupled to it. Being communicably coupled to the gate controller system 22 via the Internet 26, the remote terminal 28 may monitor and control the components and devices that are communicably coupled to the gate controller system 22. The advantage to this type of architecture is that the remote terminal 28 can receive information from or interact with any of the components coupled to the gate controller system 22, but each of the devices is not required to be directly connected to the Internet 26. Hence, the gate controller system 22 acts a mediator. Also, each device does not have to be compatible with the remote terminal 28, but rather only needs to be compatible with the gate controller system 22. Preferably, the software on the gate controller system 22 is plug-and-play. That is, numerous devices can be easily connected to the gate controller system 22 as desired so that a parking garage owner or manager can upgrade the systems more easily. This should provide user-friendly features and ease of adding options to the system.

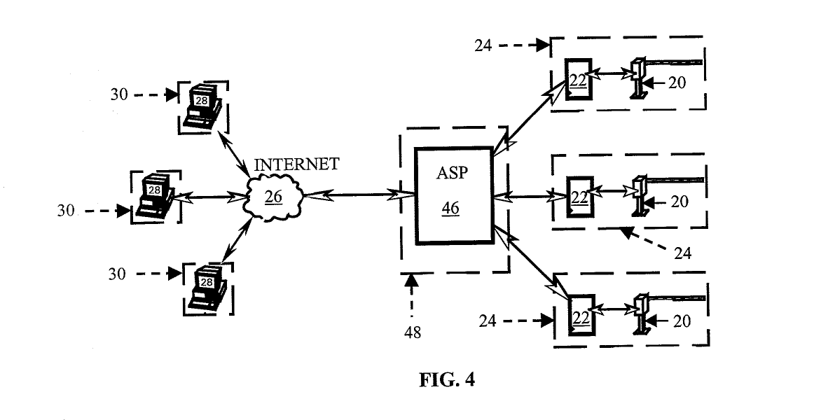

FIG. 4 is a simplified schematic of a fourth embodiment of the present invention. The fourth embodiment is an example of an application service provider (ASP) model incorporated into the present invention. As shown in FIG. 4, three gate controller systems 22 for three parking garages at three different locations 24 are communicably coupled to an ASP computer system 46. At each location 24 there is a gate 20 controlled by a corresponding gate controller system 22. As in the third embodiment discussed above, other devices also can be communicably coupled to each of the gate controllers 22 to expand the capabilities of the system and enhance the functionality of the system. With the ASP model, the software required to run the gate controller systems 22 is supplied by the ASP computer system 46. The software may run on the ASP computer system 46 and/or the gate controller systems 22 to perform tasks and procedures at the gate controller systems 22. Also, the ASP computer system 46 may comprise a database where information and data generated by the gate controller systems 22 or by devices communicably coupled to the gate controller systems 22 relating to, e.g., gate activity and/or parking garage usage can be stored. Furthermore, the ASP computer system 46 may comprise a database containing information used for comparison and authentication of a person's identity, such as: voice data for voice recognition comparisons, image data for visual comparison, passwords, codes, access card numbers, reference information, patron information, emergency contact information, and attendant log-in information.

The application service provider computer system 46 may provide code and data adapted to generate a web site that allows users at a remote location 30 to interact with the gate controller system 22 via the Internet 26. Hence, a user could log into the web site from anywhere via the Internet 26 and interact with a gate controller system 22 to monitor or control a gate 20.

An advantage to the ASP model is that if the software for the gate controller systems 22 needs to be modified or upgraded to a newer version, the new or revised software may be loaded on the ASP computer system 46 one time to effect all of the gate controller systems 22 connected to the ASP computer system 46. So instead of having to physically go to each gate controller system 22 and load the updated software (e.g., via CD-ROMs or diskettes), it can simply be loaded onto the ASP computer system 46 for all the gate controller system locations 24. Another advantage is that the ASP computer system 46 can act as the conduit to the Internet 26 for all of the gate controller systems 22.

Yet another advantage of the ASP model is that one service provider company may manage the monitoring and control of numerous gate controller systems for numerous clients. Thus, the service provider may arrange schedules and handle the logistics of contracting with numerous companies or persons providing “virtual” parking attendant services at numerous remote terminals in numerous locations. Hence, the parking garage owner or manager can simply contract with the service provider and rely on the service provider to provide the “virtual” parking attendants to monitor and control the parking garage gates. Therefore, the fourth embodiment provides a convenient and efficient way to link up numerous remote terminals 28 with numerous gate controller systems 22 via the Internet 26, as illustrated in FIG. 4.

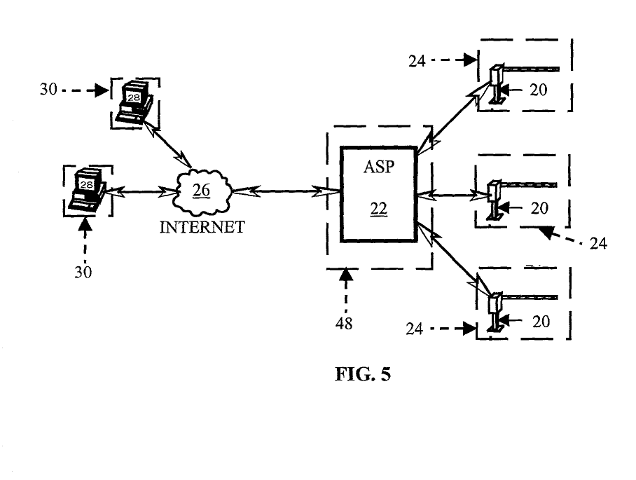

FIG. 5 is a simplified schematic of a fifth embodiment of the present invention. The fifth embodiment is a variation on the fourth embodiment in that the ASP computer system is the gate controller system 22 for numerous gates 20 at numerous locations 24. Each gate has hardware allowing it to receive and follow motion control commands from the gate controller system 22. Thus, each gate 20 has just the essential hardware and/or software needed to perform the tasks of controllably moving the gate 20 (e.g., speed controller for gate motors, feedback encoders and/or sensors for providing gate position information). A gate 20 may further comprise other devices for interacting with a patron (e.g., touch screen monitor, microphone, speaker, card reader), as described above for the third embodiment. Such devices may also be fully controlled and driven by the gate controller system 22. Again, the gate controller system 22 preferably comprises plug-and-play software to allow numerous combinations of auxiliary devices to be added to the system for interacting with a parking garage patron, monitoring the parking garage, and/or receiving payment or authorization information from a parking garage patron. As in the fourth embodiment, the fifth embodiment provides one access point—the gate controller system 22 (e.g., one web site operated from the gate controller system 22)—for linking numerous remote terminals 28 to numerous gates 20 via the Internet 26, as illustrated in FIG. 5.

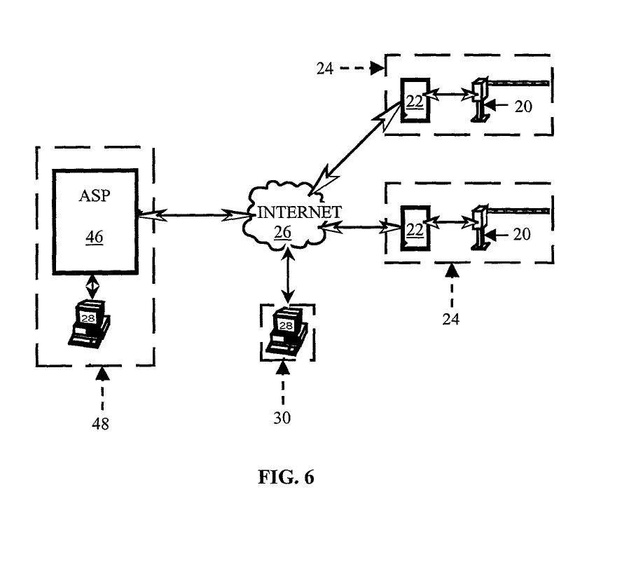

FIG. 6 is a simplified schematic of a sixth embodiment of the present invention. In the sixth embodiment, each gate controller system 22 at each location 24 is communicably coupled to an ASP computer system 46 at another location 48 via the Internet 26. Also, each gate controller system 22 is communicably coupled to a remote terminal 28 at a remote location 30 via the Internet 26. The sixth embodiment is similar to that of the fourth embodiment above, except that the ASP computer system 46 is communicably coupled via the Internet 26. Also, the gate controller systems 22 can utilize resources at the ASP computer system 46 as needed, but need not be communicably coupled to the remote terminal 28 via the ASP computer system 46. As a variation or if needed, the gate controller systems 22 may be communicably coupled to the remote terminal 28 via the ASP computer system 46 (not shown in FIG. 6), yet still communicably coupled to the ASP computer system 46 via the Internet 26. In one use of the present invention, the ASP computer system 46 could be used to receive, process, authenticate, and authorize passage through a gate 20 in an automated manner (e.g., if the patron inserts an access card having a number matching a valid monthly contract patron account number stored in a database at the ASP computer system 46). And a person at the remote terminal 28 may only be contacted as needed when an automated authorization attempted by the ASP computer system 46 fails or when a patron presses a call button for assistance.

It will be appreciated by those skilled in the art having the benefit of this disclosure that this invention provides a system and method of remotely controlling and/or monitoring a parking garage gate or parking lot access gate via an open network, such as the Internet. It should be understood that the drawings and detailed description herein are to be regarded in an illustrative rather than a restrictive manner, and are not intended to limit the invention to the particular forms and examples disclosed. On the contrary, the invention includes any further modifications, changes, rearrangements, substitutions, alternatives, design choices, and embodiments apparent to those of ordinary skill in the art, without departing from the spirit and scope of this invention, as defined by the following claims. Thus, it is intended that the following claims be interpreted to embrace all such further modifications, changes, rearrangements, substitutions, alternatives, design choices, and embodiments.

The invention claimed is:

1. A system for remotely controlling passage through a gate at a parking garage, comprising:
a gate controller system located at a parking garage and being adapted to control the movement of said gate; and
a remote terminal at a remote location, said remote terminal being communicably coupled to said gate controller via an open network.

2. A system in accordance with claim 1, wherein said gate controller system comprises:
a computer system having a processor, disk drive, and memory; and
a modem adapted to communicably couple said computer system to said open network.

3. A system in accordance with claim 1, wherein said open network connection to said open network is a secure connection using cryptography.

4. A system in accordance with claim 1, wherein said open network is the Internet.

5. A system in accordance with claim 1, further comprising a touch screen monitor, said monitor being communicably coupled to said gate controller system, wherein said monitor provides a graphical user interface between a user and said gate controller system.

6. A system in accordance with claim 1, further comprising a keypad communicably coupled to said gate controller system.

7. A system in accordance with claim 1, further comprising a video camera communicably coupled to said gate controller system.

8. A system in accordance with claim 7, wherein said video camera is a digital video camera adapted to generate digital representations of images shot with said camera.

9. A system in accordance with claim 1, further comprising a microphone communicably coupled to said gate controller system.

10. A system in accordance with claim 1, further comprising a speaker communicably coupled to said gate controller system.

11. A system in accordance with claim 1, further comprising a vehicle license plate scanning system communicably coupled to said gate controller system.

12. A system in accordance with claim 1, further comprising a credit card reader communicably coupled to said gate controller system.

13. A system in accordance with claim 1, further comprising an ATM card reader communicably coupled to said gate controller system.

14. A system in accordance with claim 1, further comprising a cash intake machine communicably coupled to said gate controller system.

15. A system in accordance with claim 1, further comprising an access card scanner communicably coupled to said gate controller system.

16. A system in accordance with claim 1, further comprising a pre-paid card reader communicably coupled to said gate controller system.

17. A system in accordance with claim 1, further comprising a finger print scanner communicably coupled to said gate controller system.

18. A system in accordance with claim 1, further comprising an eye scanner communicably coupled to said gate controller system.

19. A system in accordance with claim 1, further comprising a microphone communicably coupled to said gate controller system, and wherein said gate controller system further comprises a database comprising voice data, and said gate controller system further comprises a voice recognition program adapted to compare a voice received from said microphone to said voice data to authenticate a person's identity.

20. A system in accordance with claim 1, further comprising a bar code scanner communicably coupled to said gate controller system.

21. A system in accordance with claim 1, further comprising a chip reader communicably coupled to said gate controller system.

22. A system in accordance with claim 1, further comprising a radio receiver communicably coupled to said gate controller system and adapted to receive signals from a radio transmitter.

23. A system in accordance with claim 1, wherein said remote terminal comprises:
a computer system having a processor, disk drive, and memory, and
a modem adapted to communicably couple said computer system to said open network.

24. A system in accordance with claim 1, wherein said remote terminal comprises a video monitor communicably coupled to a video camera via said open network, wherein said video camera is within viewing distance from said gate.

25. A system in accordance with claim 1, wherein said remote terminal comprises a microphone and a speaker.

26. A system in accordance with claim 1, wherein said remote terminal comprises a database having information relevant to said gate.

27. A system in accordance with claim 1, wherein said gate controller system comprises an application service provider system.

28. A system in accordance with claim 27, further comprising an additional gate, said additional gate being adapted to move in response to signals from said application service provider system.

29. A web based parking garage gate system, comprising:
a gate controller system located at a parking garage and being adapted to control the movement of a parking garage gate at said parking garage;
an application service provider computer system located remotely from said gate controller system, said gate controller system being communicably coupled to said application service provider computer system, said application service provider computer system comprising code and data adapted to generate a web site that allows users at a remote location to interact with said gate controller system via the Internet.

30. A system in accordance with claim 29, wherein said interaction with said gate controller system includes the ability to send motion control commands to said gate controller system using said web site.

31. A system in accordance with claim 29, wherein said interaction with said gate controller system includes the ability to monitor data from said gate controller system relating to said parking garage gate.

32. A system in accordance with claim 29, wherein said interaction with said gate controller system includes the ability to program settings for said gate controller system.

33. A system in accordance with claim 29, wherein said interaction with said gate controller system includes the ability to download a report detailing recorded data regarding said parking garage gate.

34. A system in accordance with claim 29, wherein said interaction with said gate controller system includes the ability to transfer data from said gate controller system to said users at said remote location.

35. A system in accordance with claim 29, wherein said interaction with said gate controller system includes the ability to change gate control features from said remote location using said web site.

36. A system in accordance with claim 29, wherein said gate controller system comprises a microprocessor, a storage medium, and memory.

37. A system in accordance with claim 29, wherein said gate controller system comprises a touch screen monitor interface for patrons at said gate to interact with said gate controller system.

38. A system in accordance with claim 29, further comprising a camera communicably coupled to said gate controller system.

39. A system in accordance with claim 38, wherein said interaction with said gate controller system includes the ability to view images from said camera from said remote location via said web site.

40. A system in accordance with claim 38, wherein said interaction with said gate controller system includes the ability to control the position of said camera from said remote location using said web site.

41. A system in accordance with claim 29, further comprising a microphone and speaker at said gate and communicably coupled to said gate controller system, and wherein said interaction with said gate controller system includes the ability to talk to a patron at said gate from said remote location via said web site.

42. A system in accordance with claim 29, wherein said gate controller system is communicably coupled to said application service provider computer system via a secure open network connection.

43. A system in accordance with claim 29, wherein said gate controller system is communicably coupled to said application service provider computer system via the Internet.

44. A system in accordance with claim 29, wherein said gate controller system is communicably coupled to said application service provider computer system via a dedicated line.

45. A system in accordance with claim 29, wherein said gate controller system is communicably coupled to said application service provider computer system via a wireless communication system.

46. A system in accordance with claim 29, wherein said gate controller system is communicably coupled to said application service provider computer system via a radio frequency channel.

47. A system in accordance with claim 29, wherein said gate controller system is communicably coupled to said application service provider computer system via a satellite communication system.

48. A system for controlling passage through a gate for a parking garage, comprising:
a first computer system located at said parking garage, said first computer system being adapted to control the movement of said parking garage gate and being communicably coupled to the Internet; and
a second computer system located remotely from said first computer system, said second computer system being capable of communicably coupling to the Internet as needed; and
a server computer system comprising a software program adapted to provide code and data to said second computer system via the Internet, said code and data being adapted to output a graphical user interface with text on said second computer system, wherein said graphical user interface with text comprises an interface to allow a user at said second computer system to control said parking garage gate remotely via the Internet.

49. A system in accordance with claim 48, wherein said first computer system is said server computer system.

50. A system in accordance with claim 48, wherein said server computer system is located remotely from said first computer system.

51. A system in accordance with claim 48, wherein said graphical user interface is a web site and said second computer system comprises a browser software application adapted to view said web site.

52. A system in accordance with claim 48, wherein said code and data further comprises image data from a camera proximate to said gate such that said graphical user interface allows said user to view said gate using said image data.

53. A system in accordance with claim 48, further comprising:
a first microphone and a first speaker at said gate;
a second microphone and a second speaker at said second computer system, such that said user can communicate with a patron of said parking garage via the Internet.

54. A system in accordance with claim 48, further comprising a touch screen monitor at said gate, said touch screen monitor being communicably coupled to said first computer system, wherein said first computer system comprises software adapted to provide a second graphical user interface on said monitor such that a patron of said parking garage can interact with said first computer system using said monitor.

55. A parking garage gate system, comprising:
a gate controller system located at a parking garage and being adapted to control the movement of said parking garage gate; and
an application service provider computer system located remotely from said gate controller system and said gate, said gate controller system being communicably coupled to said application service provider computer system via the Internet, said application service provider computer system comprising a software program adapted to interact with and control said gate controller system from said remote location.

56. A system for controlling the usage of a parking garage, comprising:
a gate at least partially blocking an automobile passageway for said parking garage;
a gate controller system located at said parking garage and being adapted to control the movement of said gate;
a remote terminal located at a remote location apart from said parking garage, said remote terminal being communicably coupled to said gate controller system via the Internet; and
a software program adapted to run on said remote terminal and adapted to allow a user at said remote location to be in command of said gate controller system.

57. A system in accordance with claim 56, further comprising one or more additional gates adapted to being controlled by said gate controller system, wherein said software program allows said user to control any combination of said gates.

58. A system in accordance with claim 56, further comprising:
an additional gate at least partially blocking an additional automobile passageway for said parking garage; and
a corresponding additional gate controller system for said additional gate, said additional gate controller system being located at said parking garage and being adapted to control the movement of said additional gate, wherein said remote terminal is communicably coupled to said additional gate controller via the Internet, and wherein said software program is further adapted to allow said user at said remote location to be in command of said additional gate controller system.

59. A method of controlling passage through a parking garage gate, comprising the steps of:
providing a gate controller system located at a parking garage and being adapted to control the movement of said gate;
providing a remote terminal at a remote location apart from said parking garage, said remote terminal being communicably coupled to said gate controller system via an open network;
sending a command from said remote terminal to said gate controller system via said open network; and
moving said gate with said gate controller system in response to said command from said remote terminal.

60. A method in accordance with claim 59, further comprising the steps of:
providing a touch screen monitor that is communicably coupled to said gate controller system;
providing a graphical user interface on said monitor;
inputting information into said gate controller system via said monitor; and
transmitting said inputted information from said gate controller system to said remote terminal via said open network.

61. A method in accordance with claim 59, further comprising the steps of
providing a communication system at said gate; and
communicating with a patron at said gate from said remote terminal using said communication system via said open network.

62. A method in accordance with claim 59, further comprising the step of:
establishing a secure open network connection between said gate controller system and said remote terminal via said open network using cryptography.

63. A method in accordance with claim 59, further comprising the steps of:
providing a video camera proximate to said gate, wherein said video camera is communicably coupled to said gate controller system;
transmitting images from said video camera to said remote terminal by said gate controller system and via said open network; and
viewing a patron at said gate from said remote terminal using said transmitted images.

64. A method in accordance with claim 63, further comprising the steps of:
visually authenticating the identity of said patron at said remote terminal using said transmitted images;
if said patron is authorized to pass through said gate and if said visually authentication sufficiently confirms said patron's identity, then performing said sending command step from said remote terminal so that said moving gate step will occur; and
allowing said patron to pass through said gate.

65. A method in accordance with claim 59, further comprising the step of:
storing data relating to said moving of said gate on a storage medium at said gate controller system.

66. A method in accordance with claim 59, further comprising the steps of:
transmitting data relating to said moving of said gate to said remote terminal via said open network; and
storing at least part of said transmitted data on a storage medium at said remote terminal.

67. A method in accordance with claim 59, further comprising the steps of:
receiving input at said gate controller system relating to authorization of a patron to pass through said gate;
transmitting said received input from said gate controller system to said remote terminal;
processing said received input at said remote terminal to determine whether said patron is authorized to pass through said gate;
if said patron is authorized to pass through said gate, then performing said sending command step from said remote terminal so that said moving gate step will occur; and
allowing said patron to pass through said gate.

68. A method in accordance with claim 67, wherein said receiving input step involves said patron providing cash payment at said gate.

69. A method in accordance with claim 67, wherein said receiving input step involves said patron inputting credit card information at said gate.

70. A method in accordance with claim 69, wherein said inputting credit card information step involves the use of a credit card reader.

71. A method in accordance with claim 69, wherein said inputting credit card information step involves the use of a keypad.

72. A method in accordance with claim 69, wherein said inputting credit card information step involves the use of a touch screen monitor with a graphical user interface.

73. A method in accordance with claim 67, wherein said receiving input step involves said patron inputting ATM card information at said gate.

74. A method in accordance with claim 73, wherein said inputting ATM card information step involves the use of a ATM card reader.

75. A method in accordance with claim 73, wherein said inputting ATM card information step involves the use of a keypad.

76. A method in accordance with claim 73, wherein said inputting ATM card information step involves the use of a touch screen monitor with a graphical user interface.

77. A method in accordance with claim 67, wherein said receiving input step involves said patron inputting cash in a cash receiving machine at said gate.

78. A method in accordance with claim 67, wherein said receiving input step involves said patron scanning a pre-paid card at said gate.

79. A method in accordance with claim 67, wherein said receiving input step involves said patron scanning an access card at said gate.

80. A method in accordance with claim 67, wherein said receiving input step involves scanning a toll tag device on a vehicle of said patron at said gate.

81. A method in accordance with claim 67, wherein said receiving input step involves scanning at least one fingerprint of said patron at said gate.

82. A method in accordance with claim 67, wherein said receiving input step involves scanning at least one eye of said patron at said gate.

83. A method in accordance with claim 67, wherein said receiving input step involves scanning a bar code at said gate.

84. A method in accordance with claim 67, wherein said receiving input step involves scanning a validated ticket at said gate.

85. A method in accordance with claim 67, wherein said receiving input step involves scanning a time stamped ticket at said gate.

86. A method of controlling passage of a vehicle of a parking garage patron through an unmanned gate at a parking garage, comprising the steps of:
providing a first computer system at said parking garage, said first computer system being communicably coupled to the Internet via a secure connection;
providing a mechanism at said gate, said mechanism being adapted to move said gate in response to control signals from said first computer system;
providing a second computer system located at a remote location relative to said first computer system and said parking garage, wherein said second computer system is adapted to be communicably coupled to the Internet as needed;
communicating with said patron at said gate from said remote location using said computer systems and via the Internet;
authorizing passage of said patron through said gate from said remote location;
sending a gate movement command from said second computer system to said first computer system via the Internet; and
moving said gate to allow said patron to pass through said gate based on said gate movement command.

87. A method in accordance with claim 86, wherein a web page display is provided to a browser on said second computer system via the Internet for a user at said remote location to interact with said first computer system.

88. A method in accordance with claim 86, further comprising the step of:
controlling said mechanism from said remote location using said second computer system.

89. A method in accordance with claim 86, further comprising the steps of:
providing a first graphical user interface at said gate for said patron, said first graphical user interface being communicably coupled to said first computer system;
said communicating with said patron step comprising the step of prompting said patron to input information at said gate via said first graphical user interface;
transmitting said inputted information to said second computer system with said first computer system and via the Internet; and
said authorizing passage step being performed by said second computer system based on said inputted information from said patron.

90. A method in accordance with claim 89, further comprising the step of:
comparing said inputted information to database information stored at said second computer system to determine if said patron should be authorized to pass through said gate.

91. A method in accordance with claim 89, wherein said graphical user interface is a touch screen monitor.

92. A method in accordance with claim 86, further comprising the step of:
providing a first microphone and a first speaker at said gate, said first microphone and speaker being communicably coupled to said first computer system;
providing a voice recognition program; and
wherein said communicating with said patron step comprises the steps of:
asking said patron questions with a computer generated voice via said first speaker at said gate,
receiving a voice response from said patron with said first microphone at said gate,
converting said voice response from said patron into a digital form that a computer can understand using said voice recognition program, and
reacting to said voice response from said patron based on a set of logic rules and algorithms.

93. A method in accordance with claim 92, further comprising the steps of:
providing a second microphone and a second speaker at said remote location, said second microphone and speaker being communicably coupled to said second computer system; and
verbally communicating with said patron from said remote location, wherein said voice data is transmitted between said first and second computer systems via the Internet.

94. A method in accordance with claim 86, further comprising the step of:
providing a second graphical user interface at said remote location for said user, said second graphical user interface being communicably coupled to said second computer system; and
controlling said gate at said parking garage using said second graphical user interface.

95. A method of providing remote assistance at a parking gate of a parking facility, comprising the steps of:
providing a first computer system at said parking facility, said first computer system being communicably coupled to said Internet via a secure connection;
providing a mechanism at said gate, said mechanism being adapted to move said gate in response to control signals from said first computer system;
providing an interface system at a payment transaction device being adapted to transmit and receive audio and video information for communicating with a parking patron;
providing a presence detection device to sense the presence of said patron at said payment transaction device;
providing a second computer system located at a remote location relative to said first computer system and said parking facility, wherein said second computer system is adapted to be communicably coupled to said Internet as needed;
communicating with said patron at said gate from said remote location using said computer systems and via said Internet;
providing assistance in processing payments via an onsite cash accepter or an onsite credit card processor or an offsite credit card processor;
authorizing passage of said patron through said gate from said remote location;
sending a gate movement command from said second computer system to said first computer system via said Internet; and
moving said gate to allow said patron to pass through said gate based on said gate movement command.

96. A method in accordance with claim 95, wherein said interface system comprises a touch screen monitor.

97. A method in accordance with claim 95, wherein said interface system comprises a video camera, a microphone, and a speaker.

98. A method in accordance with claim 95, further comprising the steps of:
providing a voice recognition program; and
wherein said communicating with said patron step further comprises the steps of:
asking said patron questions with a computer generated voice,
receiving a voice response from said patron,
converting said voice response from said patron into a digital form that a computer can understand using said voice recognition program, and
reacting to said voice response from said patron based on a set of logic rules and algorithms.

99. A method in accordance with claim 98, further comprising the steps of:
comparing said converted voice response to voice data; and
storing said voice data in a database to identify said patron.

100. A method in accordance with claim 95, further comprising the steps of:
recording at least part of said communicating with said patron step.
